(19) United States
(12) Patent Application Publication
(10) Pub. No.: US 2026/0125082 A1
(43) Pub. Date: May 7, 2026

(54) VEHICLE CONTROL MODE SWITCHING DEVICE

(71) Applicant: TOYOTA JIDOSHA KABUSHIKI KAISHA, Toyota-shi (JP)

(72) Inventors: Kumiko KONDO, Numazu-shi (JP); Shinya KAWAMATA, Mishima-shi (JP); Tomoyuki DOI, Toyota-shi (JP); Shogo ITO, Sunto-gun (JP)

(73) Assignee: TOYOTA JIDOSHA KABUSHIKI KAISHA, Toyota-shi (JP)

(21) Appl. No.: 19/347,241

(22) Filed: Oct. 1, 2025

(30) Foreign Application Priority Data
Nov. 1, 2024 (JP) 2024-192880

(51) Int. Cl. B60W 60/00; B60W 50/14; B62D 1/04; B60K 23/02

(52) U.S. Cl. CPC B60W 60/005; B60W 50/14; B62D 1/046; B60K 23/02; B60W 2050/146; B60W 2540/215

(57) ABSTRACT

A vehicle control mode switching device that switches a control mode between a non-control mode in which a control amount is not changed automatically, an auto mode in which the control amount is changed automatically, and a manual mode in which the control amount is changed manually, and includes a first operating device and a second operating device operated by a driver, and an electronic control unit configured to switch the control mode based on the operation of the first and second operating devices, in which the electronic control unit switches the controlmode between two modes of the three modes to set a base mode based on the operation of the first operating device, and switches the control mode between the base mode and a remaining mode other than the two modes among the three modes based on the operation of the second operating device.

### CROSS-REFERENCE TO RELATED APPLICATION

This application claims priority to Japanese Patent Application No. JP2024-192880 filed on November 1, 2024, the content of which is hereby incorporated by reference in its entirety into this application.

### BACKGROUND

### 1. Technical Field

The present disclosure relates to a control mode switching device for vehicles such as automobiles.

### 2. Description of the Related Art

In vehicles such as automobiles, a control mode switching device is known that switches a control mode of a vehicle in response to operation of an operating device. For example, Japanese Patent Application Laid-open Publication No. 2022-72666 describes a control mode switching device that switches a driving mode of a vehicle between an electric mode and a hybrid mode and switches a gear ratio of an automatic transmission by operating a paddle shift lever.

In a control of vehicles such as automobiles, a control mode may be switched between a non-control mode in which a control amount is not changed automatically, an auto mode in which the control amount is changed automatically, and a manual mode in which the control amount is changed manually.

In conventional control mode switching devices such as that described in the above-mentioned Japanese Patent Application Laid-open Publication, when switching a control mode between three modes by operating one or a type of operating devices such as a paddle shift lever, the operation of the operating device inevitably becomes complex. Therefore, when switching the control mode, there is a high likelihood of incorrectly operating the operating device.

### SUMMARY

The present disclosure provides a vehicle control mode switching device that is improved so that operating errors of an operating device are less likely to occur when switching a control mode between three modes, compared to conventional control mode switching devices.

According to the present disclosure, a vehicle control mode switching device is provided that switches a control mode between a non-control mode in which a control amount is not changed automatically, an auto mode in which the control amount is changed automatically, and a manual mode in which the control amount is changed manually.

The control mode switching device comprises: first and second operating devices operated by a driver; and an electronic control unit configured to switch the control mode based on operation of the first and second operating devices, and the electronic control unit is configured to switch the control mode between two modes of the three modes to set one of the two modes as a base mode based on the operation of the first operating device, and to switch the control mode between the base mode and a remaining mode other than the two modes among the three modes based on the operation of the second operating device.

According to the above configuration, the control mode is switched between two modes of the three modes to set one of the two modes as the base mode based on the operation of the first operating device. Therefore, the driver can switch the control mode between the two modes to set the base mode by operating the first operating device. Furthermore, according to the above configuration, the control mode is switched between the base mode and the remaining mode other than the two modes based on the operation of the second operating device. Accordingly, the driver can switch the control mode between the base mode and the remaining mode by operating the second operating device. Therefore, according to the above configuration, compared to a conventional device that switches the control mode between three modes by operating one or a type of operating devices, it is possible to reduce a risk of operating the operating device incorrectly when switching the control mode between three modes.

In one aspect of the present disclosure, the second operating device is provided in a position that is easier for the driver to access while driving a vehicle than the first operating device.

According to the above aspect, the second operating device is easier for the driver to operate while driving the vehicle than the first operating device. Therefore, switching the control mode between the base mode and the remaining mode is easier than switching the control mode between the two modes to be set as the base mode.

In another aspect of the present disclosure, the operation of the second operating device for switching the control mode between the base mode and the remaining mode is the same regardless of which of the two modes the base mode is.

According to the above aspect, it is possible to easily switch the control mode between the base mode and the remaining mode compared to when the operation of the second operating device differs depending on which of the two modes the base mode is.

In another aspect of the present disclosure, the electronic control unit is configured such that, when switching the control mode from the remaining mode to the base mode based on the operation of the second operating device, the control mode is switched to a mode that was set as the base mode before switching the control mode from the base mode to the remaining mode.

In the present application, the mode that was set as the control mode before switching the control mode from the base mode to the remaining mode is referred to as an “original mode.” According to the above configuration, when the control mode is switched from the remaining mode to the base mode based on the operation of the second operating device, the control mode is switched to the original mode. Therefore, when switching the control mode from the remaining mode to the base mode based on the operation of the second operating device, the control mode can be switched to the original mode.

In another aspect of the present disclosure, the two modes are the non-control mode and the auto mode, and the remaining mode is the manual mode.

According to the above aspect, the two modes are the non-control mode and the auto mode. Therefore, the control mode can be switched between the non-control mode and the auto mode to be set as the base mode by operating the first operating device, and the control mode can be switched between the base mode and the manual mode by operating the second operating device.

In yet another aspect of the present disclosure, the electronic control unit is configured such that, when switching the control mode from the auto mode to the manual mode based on the operation of the second operating device in a situation where the control mode is the auto mode, increase or decrease in the control amount when switching the control mode from the auto mode to the manual mode is determined based on an operation manner of the second operating device.

According to the above aspect, when switching the control mode from the auto mode to the manual mode, the driver can increase or decrease the control amount when switching the control mode from the auto mode to the manual mode as desired by selecting the operation manner of the second operating device.

In another aspect of the present disclosure, the two modes are the non-control mode and the manual mode, and the remaining mode is the auto mode.

According to the above aspect, the two modes are the non-control mode and the manual mode. Therefore, the control mode can be switched between the non-control mode and the manual mode to set the base mode by operating the first control device, and the control mode can be switched between the base mode and auto mode by operating the second control device.

In another aspect of the present disclosure, the electronic control unit is configured such that, when switching the control mode from the auto mode to the manual mode based on the operation of the second operating device in a situation where the control mode is the auto mode, increase or decrease in the control amount when switching the control mode from the auto mode to the manual mode is determined based on an operation manner of the second operating device.

According to the above aspect, when switching the control mode from the auto mode to the manual mode, the driver can increase or decrease the control amount when switching the control mode from the auto mode to the manual mode as desired by selecting the operation manner of the second operating device.

In another aspect of the present disclosure, the first operating device is a switch provided at a position other than a steering wheel, and the second operating device is one of a paddle shift device and a steering switch provided on the steering wheel.

According to the above aspect, one of the paddle shift device and the steering switch as the second operating device is located in a position that is easier for the driver to access while driving the vehicle than the switch provided at the position other than the steering wheel as the first operating device. Therefore, it is easier for the driver to switch the control mode between the base mode and the remaining mode by operating one of the paddle shift device and the steering switch than to switch the control mode between the two modes by operating the switch provided at the position other than the steering wheel.

In another aspect of the present disclosure, the switch provided at the position other than the steering wheel is a soft switch that is displayed on a display device visible to the driver and can be operated by touch.

According to the above aspect, the driver can switch the control mode between the two modes to set the base mode, by touching the soft switch displayed on the display device.

In another aspect of the present disclosure, the electronic control unit is configured, when the control mode is the remaining mode, to display the control mode that was set as the base mode before the control mode was switched from the base mode to the remaining mode on the display device visible to the driver.

According to the above aspect, when the control mode is the remaining mode, an original mode, that is, the control mode that was set as the base mode before the control mode was switched from the base mode to the remaining mode is displayed on the display device. Therefore, the driver can recognize the original mode by looking at the display device.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing a driving support device equipped with a control mode switching device according to an embodiment.

FIG. 2 is a view showing an interior of a vehicle equipped with a control mode switching device according to the first embodiment.

FIG. 3 is a diagram showing a relationship between control mode switching operations and changes in control mode, with non-control mode and auto mode as a base mode and manual mode as a remaining mode.

FIG. 4 is a flowchart corresponding to a control mode switching control program in the first embodiment.

FIG. 5 is a diagram showing an interior of a vehicle equipped with a control mode switching device according to the second embodiment.

FIG. 6 is a diagram showing a relationship between control mode switching operations and changes in control mode, with non-control mode and manual mode as the base modes and auto mode as the remaining mode.

FIG. 7 shows a plurality of driving torque maps indicating relationships between accelerator opening A, vehicle speed V, and driving torque Td.

FIG. 8 is a flowchart corresponding to a control mode switching control program in the second embodiment.

### DETAILED DESCRIPTION

The present disclosure will now be described in detail with reference to the accompanying drawings.

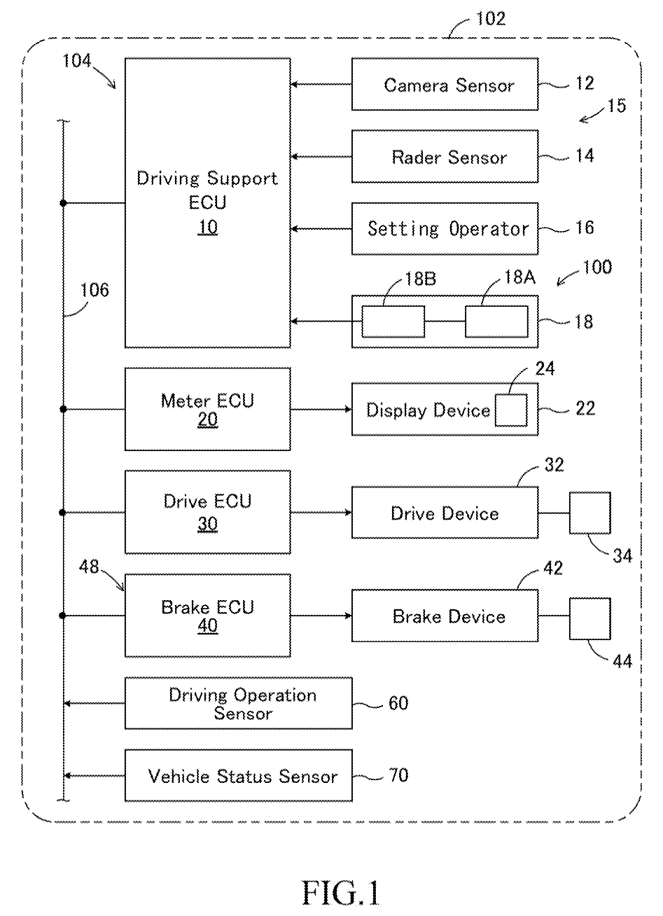

As shown in FIG. 1, a control mode switching device 100 according to the embodiment of the present disclosure is applied to a driving support device 104 of a vehicle 102 and includes a driving support ECU 10.

The vehicle 102 may be a vehicle capable of autonomous driving and is equipped with a meter ECU 20, a drive ECU 30, and a brake ECU 40. ECU refers to an electronic control unit that includes a microcomputer as its main component.

The microcomputer of each ECU includes a CPU, ROM, RAM, read/write-enabled non-volatile memory (N/M), and an interface (I/F). The CPU executes instructions (programs, routines) stored in the ROM to perform various functions. Furthermore, these ECUs are interconnected via a CAN (Controller Area Network) 106 to enable data exchange (communication) between them. Therefore, detected values from sensors (including switches) connected to a specific ECU are transmitted to other ECUs.

The driving support ECU 10 is a central control unit that executes driving support control such as deceleration support control, adaptive cruise control, and lane keeping control. In the embodiment, the driving support ECU 10 cooperates with other ECUs to execute driving support control that assists a driver in driving the vehicle 102, and further executes control mode switching control for the driving support control.

The driving support ECU 10 is connected to a camera sensor 12, a radar sensor 14, a setting operator 16, and an operating device 18. The camera sensor 12 and the radar sensor 14 each include multiple camera devices and multiple radar devices, respectively, and function as target information acquisition devices 15 that acquire target information around the vehicle 102.

Although not shown in the figure, each camera device of the camera sensor 12 includes a camera unit that photographs surroundings of the vehicle 102 and a recognition unit that analyzes image data obtained by the camera unit to recognize targets such as road white lines and other vehicles. The recognition unit supplies information about the recognized targets to driving support ECU 10 at predetermined intervals.

Each radar device of the radar sensor 14 uses millimeter-wave radio waves to detect a distance between the vehicle and a three-dimensional object, a relative velocity between the vehicle and the three-dimensional object, and a relative position (direction) of the three-dimensional object with respect to the vehicle, and supplies information representing these to the driving support ECU 10 at predetermined intervals. Note that instead of or in addition to the radar sensor 14, LiDAR (Light Detection and Ranging) may be used.

The setting operator 16 is provided at a position operable by a driver and is operable by the driver. Although not shown in FIG. 1, the setting operator 16 includes a deceleration support switch. The driving support ECU 10 executes deceleration support control when the deceleration support switch is on.

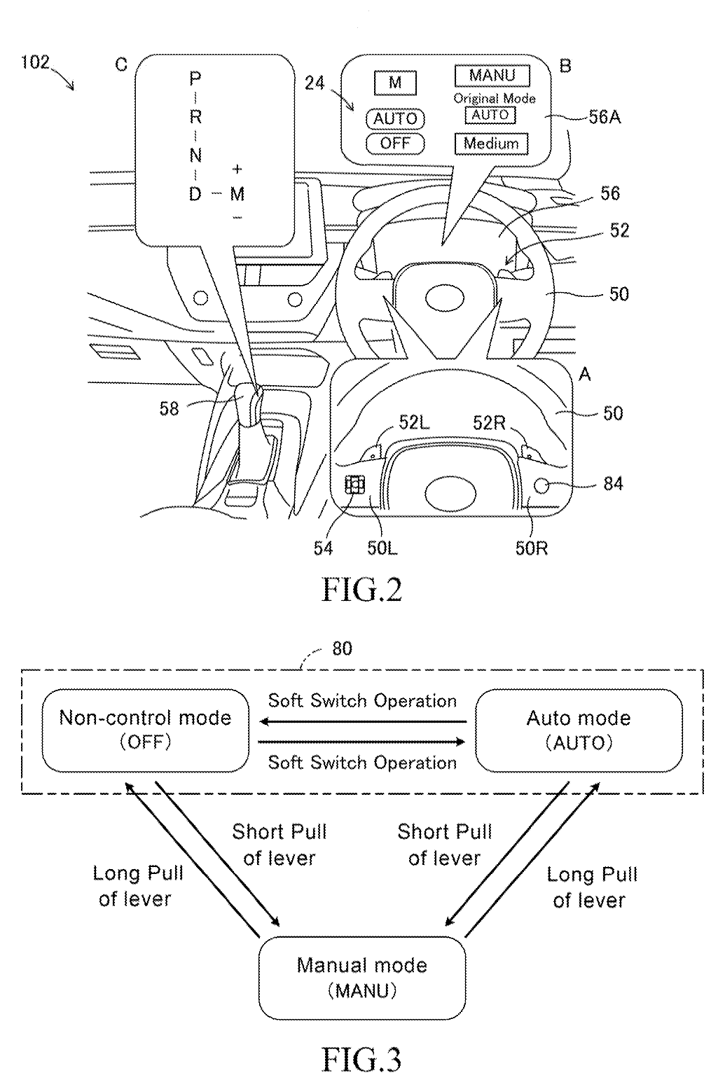

The operating device 18 includes an operating member 18A operable by the driver and a switch 18B that switches between on and off when the operating member is operated, and information on the on/off state of the switch 18B is transmitted to the driving support ECU 10. The operating device 18 is provided on a steering wheel 50 (see FIG. 2) so that it can be operated even when the driver is driving the vehicle 102. The driving support ECU 10 determines a manner of operation when the operating member 18A is operated by the driver based on the on/off status of the switch 18B.

A touch panel-type display device 22, which displays status of the control executed by the driving support ECU 10, is connected to the meter ECU 20. The display device 22 may be, for example, a meter display that displays meters and various information, particularly a multi-information display, or a monitor display of a navigation device. As described later, when the display device 22 receives a signal from the driving support ECU 10, it displays a soft switch 24, deceleration support control information, and control mode information.

The drive ECU 30 is connected to a drive device 32 that accelerates the vehicle 102 by imparting driving force to drive wheels 34. The drive ECU 30 normally controls the drive device 32 so that the driving force generated by the drive device 32 changes in response to driving operation of the driver, and when the drive ECU 30 receives a command signal from the driving support ECU 10, it controls the drive device 32 based on the command signal.

The brake ECU 40 is connected to a brake device 42 that decelerates the vehicle 102 by applying braking force to wheels 44. The wheels 44 include the drive wheels 34. The brake ECU 40 normally controls the brake device 42 so that the braking force generated by the brake device 42 changes in response to braking operation of the driver. When the brake ECU 40 receives a command signal from the driving support ECU 10, it controls the brake device 42 based on the command signal to perform automatic braking.

Thus, the brake ECU 40 and the brake device 42 function together as an automatic braking device 48. Note that when braking force is applied to the wheels 44 by deceleration support control or the like, brake lamps not shown in FIG. 1 are illuminated.

A driving operation sensor 60 and a vehicle status sensor 70 are connected to the CAN 106. Information detected by the driving operation sensor 60 and the vehicle status sensor 70 (referred to as sensor information) is transmitted to the CAN 106. The sensor information transmitted to the CAN 106 is available for use as appropriate in each ECU. Note that the sensor information is information from a sensor connected to a specific ECU, and may be transmitted from that specific ECU to the CAN 106.

The driving operation sensor 60 includes a driving operation amount sensor that detects an accelerator opening A, a braking operation amount sensor that detects a master cylinder pressure or a force applied to a brake pedal (not shown), and a brake switch that detects whether or not the brake pedal is operated. The driving operation sensor 60 also includes a steering angle sensor that detects a steering angle, a steering torque sensor that detects a steering torque, and the like.

The vehicle status sensor 70 includes a vehicle speed sensor that detects a vehicle speed V of the vehicle 102, a longitudinal acceleration sensor that detects a longitudinal acceleration of the vehicle, a lateral acceleration sensor that detects a lateral acceleration of the vehicle, and a yaw rate sensor that detects a yaw rate of the vehicle. Furthermore, the vehicle status sensor 70 includes a shift position sensor that detects a shift position (shift range) of a shift device, which is not shown in FIG. 1.

As will be explained in detail later, the soft switch 24 displayed on the display device 22 functions as a first operating device operated by the driver, and the operating device 18 functions as a second operating device operated by the driver. The control mode switching device 100 includes the first and second operating devices and the driving support ECU 10. The second operating device is provided in a position that is easier for the driver to access while driving the vehicle than the first operating device.

The driving support ECU 10 is configured to switch the control mode of deceleration support control between non-control mode and auto mode, between non-control mode and manual mode, and between auto mode and manual mode based on operation of the first and second operating devices. The non-control mode is a mode in which a control amount is not changed automatically, the auto mode is a mode in which the control amount is changed automatically, and the manual mode is a mode in which the control amount is changed manually.

The driving support ECU 10 switches the control mode between the two modes among the three modes to set one of the two modes as a base mode based on the operation of the first operating device. Furthermore, the driving support ECU 10 switches the control mode between the base mode and a remaining mode other than the two modes among the three modes based on the operation of the second operating device.

As will be explained in detail later, the operation of the second operating device for switching the control mode between the base mode and the remaining mode is the same regardless of which of the two modes the base mode is.

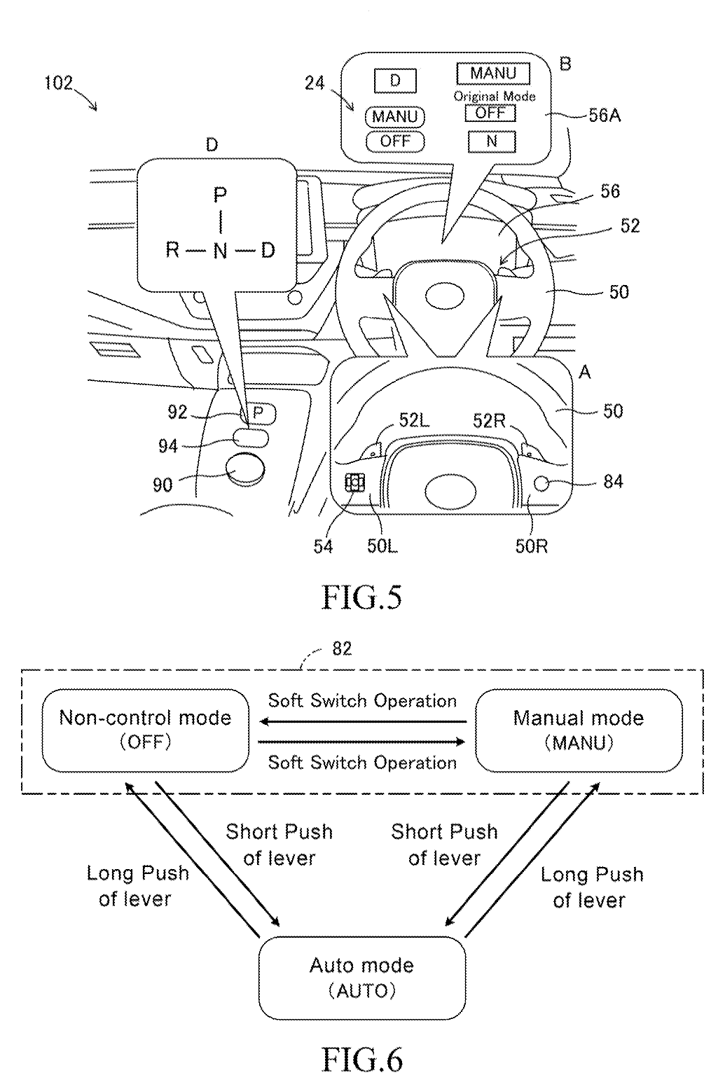

Furthermore, when switching the control mode from the remaining mode to the base mode based on the operation of the second operating device, the driving support ECU 10 switches the control mode to an original mode. As mentioned above, the original mode is a mode that was set as the control mode before the control mode was switched from the base mode to the remaining mode. The original mode is also displayed on the display device 22, for example the multi-information display 56A (see FIGS. 2 and 5).

### First embodiment

The first embodiment is applied to a vehicle including an internal combustion engine and a transmission not shown in FIG. 1. In the first embodiment, the transmission of the vehicle 102 is an automatic transmission having a manual transmission mode.

In the first embodiment, as shown in a balloon A in FIG. 2, the operating member 18A of the operating device 18 is a pair of levers 52L and 52R of a paddle shift device 52, which is provided on the left and right spokes 50L and 50R, respectively, of the steering wheel 50 and operated by fingers of the driver. The paddle shift device is a device provided on the steering wheel 50 for changing a shift position.

For example, when the left lever 52L is pulled toward the driver once, the shift position is lowered by one step (shift down), and when the lever 52L is pulled toward the driver multiple times in succession, the shift position is lowered by multiple steps. When the right lever 52R is pulled toward the driver once, the shift position is increased by one step (shift up), and when the lever 52R is pulled toward the driver multiple times in succession, the shift position is increased by multiple steps. Even if the levers 52L and/or 52R are continuously pulled for longer than a reference time, the shift position is not changed. Pulling the lever once is referred to as a “short pull,” and continuously pulling the lever is referred to as a “long pull.”

The switch 18B of the operating device 18 includes a pair of switches corresponding to the levers 52L and 52R. Each switch is normally off when the corresponding lever is not pulled, and turns on when the corresponding lever is pulled. Information on whether each switch is on or off is supplied to the driving support ECU 10.

In the first embodiment, the control amount is a deceleration degree of the vehicle when an accelerator pedal is not depressed by the driver (accelerator off state), and the driving support control is a deceleration degree switching control that switches the deceleration degree between three levels: high, medium (standard), and low. When the control mode is the non-control mode, the driving support ECU 10 does not automatically change the deceleration degree and sets it to medium. In contrast, when the control mode is the auto mode, the driving support ECU 10 changes the deceleration degree according to driving conditions of the vehicle, such as the vehicle speed V and a curvature of a road ahead of the vehicle 102. Furthermore, when the control mode is the manual mode, the driving support ECU 10 changes the deceleration degree in response to acceleration or deceleration operation of the driver using a cross switch 54 shown in FIG. 2 and the like.

The deceleration degree of the vehicle may be changed in any manner. For example, the deceleration degree may be changed by automatically changing the shift position of the transmission, or by automatically changing the shift position and/or automatically controlling the braking device 42.

As shown in a balloon B in FIG. 2, the present control mode and deceleration degree are displayed on the multi-information display 56A of the meter display 56. The display of the control mode is “OFF” when the present control mode is the non-control mode, “AUT” when the present control mode is the auto mode, and “MANU” when the present control mode is the manual mode. The display of the deceleration degree may be “High,” “Medium,” or “Low” when the deceleration degree is high, medium, or low, respectively.

In FIG. 2, a shift lever of the automatic transmission is indicated by 58. As shown in a balloon C in FIG. 2, the shift lever 58 can be switched between D range, N range, R range, P range, and M range (manual range). Furthermore, when the shift lever 58 is pushed toward + side while in M range, shift up is performed, and when the shift lever 58 is pushed toward - side while in M range, shift down is performed.

As shown in the balloon B in FIG. 2, the shift position of the transmission may also be displayed on the multi-information display 56A as an alphabet of each shift range. In particular, when the shift lever 58 is pushed toward the + side while in the M range, M+ may be displayed, and when the shift lever 58 is pushed toward the - side while in the M range, M- may be displayed.

In the first embodiment, as shown in FIG. 3, two modes to be set as a base mode 80 are the non-control mode and the auto mode, and the remaining mode is the manual mode. The soft switch 24 displayed on the multi-information display 56A as the display device 22 includes a non-control mode switch (OFF) and an auto mode switch (AUTO). The driving support ECU 10 sets the base mode to the non-control mode when the non-control mode switch is touched, and sets the base mode to the auto mode when the auto mode switch is touched. Thus, the driving support ECU 10 switches the control mode between the non-control mode and the auto mode to set one of the two modes as the base mode based on the operation of the soft switch 24 as the first operating device.

Furthermore, the driving support ECU 10 switches the base mode 80 to manual mode when the lever 52L or 52R as the operating member 18A is pulled short, and switches the manual mode to an original mode of the base mode 80 when the lever 52L or 52R is pulled long. The original mode is a control mode that was set as the base mode 80 before the control mode was switched from the base mode to the manual mode. Note that the original mode is displayed on the multi-information display 56A.

Thus, the driving support ECU 10 switches the control mode between the manual mode and the base mode based on the operation of the operating device 18 as the second operating device. In particular, when the driving support ECU 10 switches the manual mode to the base mode, it sets the control mode after the switching to the original mode. Therefore, the driver can recognize the original mode by looking at the multi-information display 56A, so that there is no need to remember the original mode.

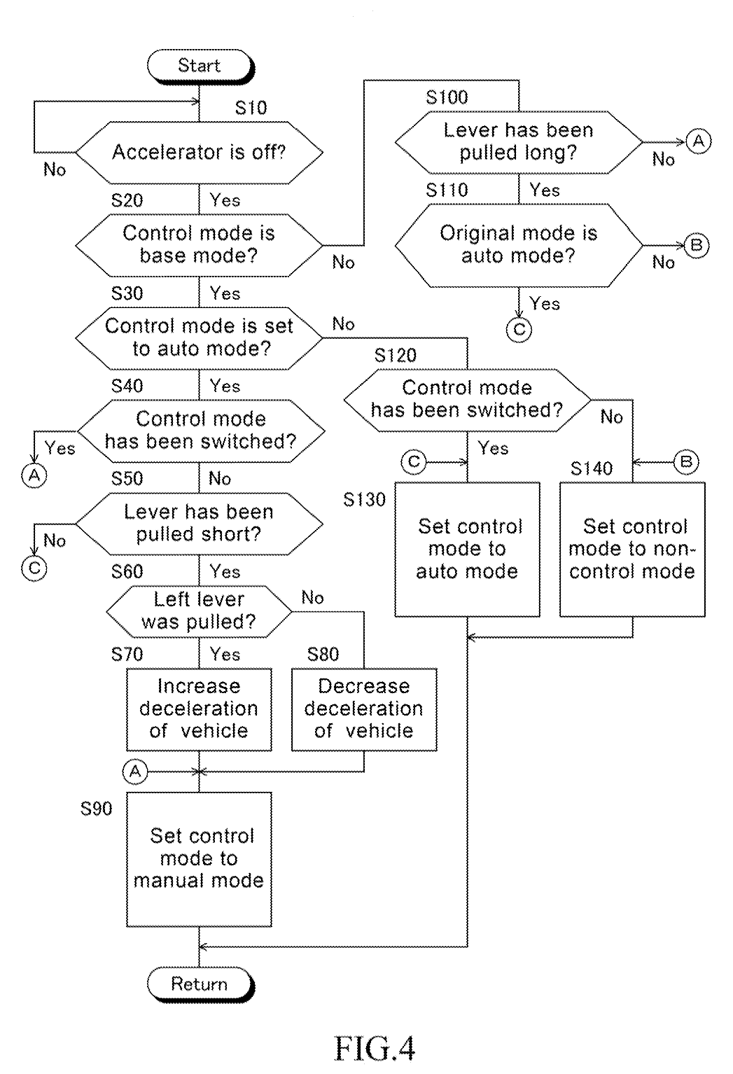

In the first embodiment, the ROM of the driving support ECU 10 stores a control mode switching control program for the deceleration degree of the vehicle when an accelerator is off, corresponding to the flowchart shown in FIG. 4. The control according to the flowchart shown in FIG. 4 is repeatedly executed at predetermined intervals by the CPU of the driving support ECU 10 when the deceleration support switch is on.

First, in step S10, the CPU determines whether or not the accelerator is off based on the accelerator opening detected by the driving operation sensor 60. When a negative determination is made, the control ends once, and when an affirmative determination is made, the control proceeds to step S20.

In step S20, the CPU determines whether or not the control mode is the base mode, i.e., whether the control mode is set to the non-control mode or the auto mode. When a negative determination is made, the control proceeds to step S100, and when an affirmative determination is made, the control proceeds to step S30.

In step S30, the CPU determines whether or not the control mode is set to the auto mode. When a negative determination is made, the control proceeds to step S120, and when an affirmative determination is made, the control proceeds to step S40.

In step S40, the CPU determines whether or not the control mode has been switched from the auto mode to the manual mode by operation of the operating device 18. When an affirmative determination is made, the control proceeds to step S90, and when a negative determination is made, the control proceeds to step S50.

In step S50, the CPU determines whether or not the lever 52L or 52R of the paddle shift device 52 has been pulled short. When a negative determination is made, the control proceeds to step S130, and when an affirmative determination is made, the control proceeds to step S60.

In step S60, the CPU determines whether or not the lever pulled was the left lever 52L. When an affirmative determination is made, in step S70, the shift position is lowered by one step, thereby increasing the deceleration of the vehicle. When a negative determination is made, in step S80, the shift position is raised by one step, thereby decreasing the deceleration of the vehicle.

In step S90, the CPU sets the control mode for switching the deceleration degree of the vehicle to the manual mode. Note that when the control mode is the manual mode, the CPU maintains the control mode in the manual mode. Additionally, the CPU outputs a command signal to the meter ECU 50 to display “MANU” on the multi-information display 56A.

In step S100, the CPU determines whether or not the lever 52L or 52R of the paddle shift device 52 has been pulled long. When a negative determination is made, the control proceeds to step S90, and when an affirmative determination is made, the control proceeds to step S110.

In step S110, the CPU determines whether or not the original mode is the auto mode. When a negative determination is made, the control proceeds to step S140, and when an affirmative determination is made, the control proceeds to step S130.

In step S120, the CPU determines whether or not the control mode has been switched from the non-control mode to the auto mode by operation of the operating device 18. When a negative determination is made, the control proceeds to step S140, and when an affirmative determination is made, the control proceeds to step S130.

In step S130, the CPU sets the control mode for switching the deceleration degree of the vehicle to the auto mode. Note that when the control mode is the auto mode, the CPU maintains the control mode in the auto mode. Additionally, the CPU outputs a command signal to the meter ECU 50 to display “AUTO” on the multi-information display 56A.

In step S140, the CPU sets the control mode for switching the deceleration degree of the vehicle to the non-control mode. Note that when the control mode is the non-control mode, the CPU maintains the control mode in the non-control mode. In addition, the CPU outputs a command signal to the meter ECU 50 to display “OFF” on the multi-information display 56A.

### Second Embodiment

The second embodiment is applied to an electric vehicle 102 including an electric motor and a transmission not shown in FIG. 5. In the second embodiment, a shift position is switched between N range (neutral), D range (drive), and R range (reverse) by rotating a shift dial 90 shown in FIG. 5. A P button 92 is provided, and pressing this button switches the shift position from other positions to P range (parking). Note that switching of all shift positions may be performed by operating shift buttons, not shown.

As shown in a balloon D in FIG. 5, a present shift position is displayed on a shift indicator 94 provided adjacent to the shift dial 90. As shown in a balloon B in FIG. 5, the shift position may also be displayed on the multi-information display 56A as the alphabet of each range.

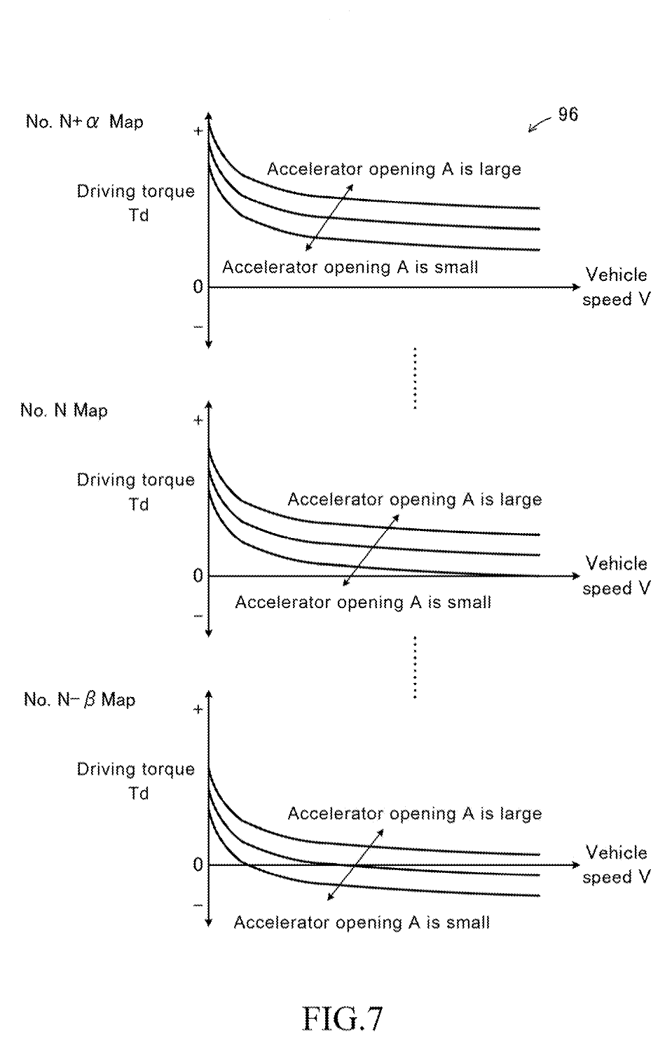

The ROM of the drive ECU 30 stores multiple driving torque maps 96 showing relationships between the accelerator opening A, the vehicle speed V, and a driving torque Td, as shown in FIG. 7. A map with number N is a standard map. As the number increases, the driving torque Td increases, and as the number decreases, the driving torque Td decreases. The driving torque Td is normally controlled based on the map with number N according to the accelerator opening angle A and the vehicle speed V. During driving force control, the driving torque maps are switched according to a required driving force.

When the driving torque Td decreases and the driving force of the vehicle 102 decreases, and the driving force becomes smaller than a sum of running resistance and friction force of the vehicle, a deceleration force acts on the vehicle. When the driving torque Td decreases and becomes negative, the deceleration force acting on the vehicle becomes even greater. Therefore, by decreasing the driving torque Td, a regenerative braking force can be controlled.

In the second embodiment, the driving support control is a control of the deceleration degree of the vehicle by controlling the driving torque Td by switching the maps. Therefore, the control amount in the second embodiment is the deceleration degree of the vehicle, which is increased or decreased by switching the maps. The driving support ECU 10 does not automatically switch the maps when the control mode is the non-control mode, and therefore does not automatically change the deceleration degree. In contrast, when the control mode is the auto mode, the driving support ECU 10 changes the deceleration degree by switching the maps based on a required deceleration degree which is determined based on, for example, the vehicle speed V and a curvature of a road ahead of the vehicle 102. Furthermore, when the control mode is manual mode, the driving support ECU 10 changes the deceleration degree by switching the maps in response to the operation of the operating device 18 by the driver, as described below.

In the second embodiment, the operating member 18A and the switch 18B of the operating device 18 are configured in the same manner as the operating member 18A and the switch 18B of the first embodiment and are used to switch the maps. In the second embodiment, the levers 52L and 52R are operated by pushing them away from the driver rather than pulling them toward the driver.

For example, when the control mode is the manual mode, each time the left lever 52L of the paddle shift device 52 is pushed once, the number of the map of the driving torque Td is decreased by one. Conversely, each time the right lever 52R of the paddle shift device 52 is pushed once, the number of the map of the driving torque Td is increased by one. Pushing the lever once is referred to as a “short push,” and pushing the lever long is referred to as a “long push.”

As shown in the balloon B in FIG. 5, the present control mode is displayed on the multi-information display 56A of the meter display 56. The control mode display is “OFF” when the present control mode is the non-control mode, “AUTO” when the present control mode is the auto mode, and “MANU” when the present control mode is the manual mode. Additionally, the map number may also be displayed on the multi-information display 56A.

In the second embodiment, as shown in FIG. 6, two modes to be set as a base mode 82 are the non-control mode and the manual mode, and the remaining mode is the auto mode. The soft switch 24 displayed on the multi-information display 56A as the display device 22 includes a non-control mode switch (OFF) and a manual mode switch (MANU). The driving support ECU 10 sets the control mode to the non-control mode when the non-control mode switch is touched, and sets the control mode to the manual mode when the manual mode switch is touched. Thus, the driving support ECU 10 switches the control mode between the non-control mode and the manual mode based on the operation of the soft switch 24 as the first operating device.

Furthermore, when the lever 52L or 52R as the operating member 18A is briefly pushed, the driving support ECU 10 switches the base mode 82 to the auto mode, and when the lever 52L or 52R is pushed long, the auto mode is switched to an original mode of the base mode 82. The original mode is a control mode that was set as the base mode 82 before the control mode was switched from the base mode to the auto mode. The original mode is also displayed on the multi-information display 56A.

Thus, the driving support ECU 10 switches the control mode between the auto mode and the base mode based on the operation of the operating device 18 as the second operating device. In particular, when the driving support ECU 10 switches the auto mode to the base mode, it sets the control mode after the switching to the original mode. Therefore, the driver can recognize the original mode by looking at the multi-information display 56A, so that there is no need to remember the original mode.

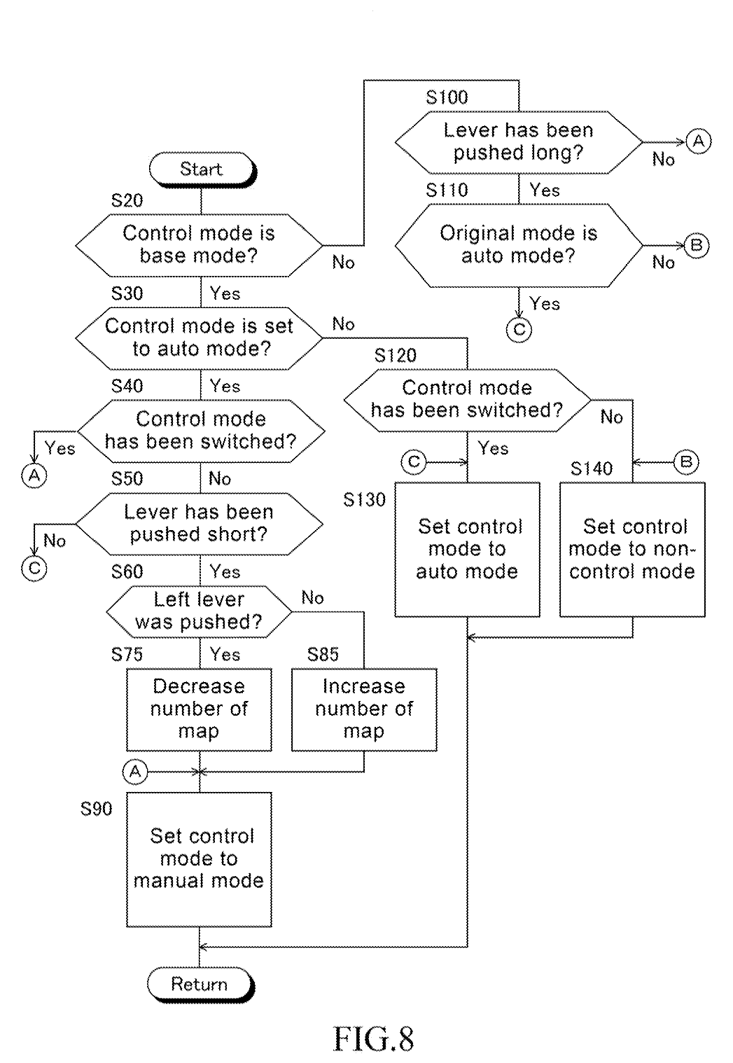

In the second embodiment, the ROM of the driving support ECU 10 stores a vehicle deceleration control program corresponding to the flowchart shown in FIG. 8. The control according to the flowchart shown in FIG. 8 is repeatedly executed at predetermined intervals by the CPU of the driving support ECU 10 while the deceleration support switch is on.

As can be seen from a comparison of FIG. 8 and FIG. 4, in the second embodiment, a step corresponding to step S10 is not executed. Steps S20 to S60, step S90, and steps S110 to S140 are executed in the same manner as steps S20 to S60, step S90, and steps S110 to S140 in the first embodiment, respectively.

In step S50, the CPU determines whether or not the lever 52L or 52R of the paddle shift device has been pushed briefly. When a negative determination is made, the driving torque maps 96 (see FIG. 7) are not switched and the control proceeds to step S130. When an affirmative determination is made, the control proceeds to step S60.

In step S60, the CPU determines whether or not the lever pushed briefly is the left lever 52L. When an affirmative determination is made, in step S75, the driving torque maps 96 are switched so that the driving torque Td is reduced by decreasing the number of the driving torque map by one. When a negative determination is made, in step S85, the driving torque maps 96 are switched so that the driving torque Td is increased by increasing the number of the driving torque map by one.

In step S100, the CPU determines whether or not the lever 52L or 52R of the paddle shift device has been pushed long. When a negative determination is made, the control proceeds to step S90, and when an affirmative determination is made, the control proceeds to step S110.

### Effects of the first and second embodiments

According to the first and second embodiments, the control mode is switched between the two modes of the three modes to set one of the two modes as a base mode based on the operation of the soft switch 24 as the first operating device. Therefore, the driver can switch the control mode between the two modes to be set as the base mode by operating the soft switch 24. Furthermore, according to the first and second embodiments, based on the operation of the second operating device 18, the control mode is switched between the base mode and a remaining mode other than the two modes among the three modes. Therefore, the driver can switch the control mode between the base mode and the remaining mode by operating the operating device 18.

Therefore, according to the first and second embodiments, compared to a conventional device in which the control mode is switched between three modes by operating one or more types of operating devices, the risk of operating the operating device incorrectly when switching the control mode between three modes can be reduced.

In the first embodiment, the two modes to be set as the base mode 80 are the non-control mode and the auto mode, and the remaining mode is the manual mode. In the second embodiment, the two modes to be set as the base mode 82 are the non-control mode and the manual mode, and the remaining mode is the auto mode.

Furthermore, according to the first and second embodiments, the second operating device 18 is positioned in a location that is easier for the driver to access while driving the vehicle 102 than the soft switch 24 as the first operating device. Therefore, the operating device 18 is easier for the driver to operate while driving the vehicle 102 than the soft switch 24. As a result, it is easier to switch the control mode between the base mode and the remaining mode than to switch the control mode between the two modes of to set the base mode.

Furthermore, according to the first and second embodiments, the operation of the operating device 18 for switching the control mode from the remaining mode to the base mode is long pulling of the lever of the paddle shift device (in the first embodiment) or long pushing of the lever (in the second embodiment). The operation of the operating device 18 for switching the control mode from the base mode to the remaining mode is short pulling of the lever (in the first embodiment) or short pushing of the lever (in the second embodiment). Thus, the operation of the operating device 18 for switching the control mode between the base mode and the remaining mode is the same regardless of which of the two modes the base mode is.

Therefore, compared to where the operation of the operating device 18 differs depending on which of the two modes the base mode is, it is possible to easily switch the control mode between the base mode and the remaining mode.

Furthermore, according to the first and second embodiments, when the control mode is switched from the remaining mode to the base mode based on the operation of the operating device 18, the control mode is switched back to the original mode. Therefore, by operating the operating device 18, it is possible to switch the control mode back to the original mode when switching the control mode from the remaining mode to the base mode.

In particular, according to the first embodiment, the base mode 80 is the non-control mode or the auto mode. Therefore, the control mode can be switched between the non-control mode and the auto mode by operation of the soft switch 24, and the control mode can be switched between the base mode and the manual mode by operation of the operating device 18.

Furthermore, according to the first embodiment, when the control mode is the auto mode and is switched to the manual mode, increase or decrease in the control amount when switching the control mode from the auto mode to the manual mode is determined based on the operation manner of the operating device 18. Therefore, the driver can increase or decrease the control amount, which is the deceleration degree, when switching the control mode from the auto mode to the manual mode, as desired by selecting the operation manner of the operating device 18.

Furthermore, according to the second embodiment, the base mode 82 is the non-control mode and the manual mode. Therefore, the control mode can be switched between the non-control mode and the manual mode by operating the soft switch 24, and the control mode can be switched between the base mode and the auto mode by operating the operating device 18.

Furthermore, according to the second embodiment, when the control mode is the auto mode and the auto mode is switched to the manual mode, increase or decrease in the control amount when switching the control mode from the auto mode to the manual mode is determined based on the operation manner of the operating device 18. Therefore, the driver can increase or decrease the control amount, which is the deceleration degree, when switching the control mode from the auto mode to the manual mode, as desired by selecting the operation manner of the operating device 18.

Furthermore, according to the first and second embodiments, the first operating device is the switch provided at a location other than the steering wheel 50, specifically, the soft switch 24 displayed on the display device 22. The second operating device is the paddle shift device 52 provided on the steering wheel 50. Therefore, the paddle shift device 52, which serves as the second operating device, is located in a position that is easier for the driver to access while driving the vehicle compared to the soft switch 24 which serves as the first operating device. As a result, switching the control mode between the base mode and the remaining mode using the paddle shift device 52 is easier than switching the control mode between the two modes of the base mode using the soft switch 24.

Furthermore, according to the first and second embodiments, the switch provided at a location other than the steering wheel 50 is the soft switch 24 that is displayed on the display device 22 (multi-information display 56A) that is visible to the driver and can be operated by touch. Therefore, the driver can switch the control mode between the two modes which belong to the base mode, by touching the soft switch 24 displayed on the display device 22.

Furthermore, according to the first and second embodiments, when the control mode is the remaining mode, the original mode is displayed on the display device 22 that is visible to the driver. Thus, the driver can recognize the original mode by looking at the display device 22.

Although the present disclosure has been described in detail with reference to specific embodiments, it will be apparent to those skilled in the art that the present disclosure is not limited to the above-described embodiments, and various other embodiments are possible within the scope of the present disclosure.

For example, in the first embodiment, the two modes to be set as the base mode 80 are the non-control mode and the auto mode, and the remaining mode is the manual mode. In the second embodiment, the two modes to be set as the base mode 82 are the non-control mode and the manual mode, and the remaining mode is the auto mode.

However, in the first embodiment, the two modes to be set as the base mode 80 may be the non-control mode and the manual mode, and the remaining mode may be the auto mode. In the second embodiment, the two modes to be set as the base mode 82 may be the non-control mode and the auto mode, and the remaining mode may be the manual mode.

Furthermore, in the first embodiment, the control amount is the deceleration degree of the vehicle that is increased or decreased by the shift change, and in the second embodiment, the control amount is the deceleration degree of the vehicle that is increased or decreased by changing the driving torque maps. However, the control amount may be any control amount for controlling the vehicle.

Furthermore, in the first and second embodiments, the second operating device is the paddle shift device 52, but it may be any operating device that is easier for the driver to operate while driving the vehicle 102 than the first operating device. For example, the second operating device may be a steering switch 84 provided on a spoke portion of the steering wheel 50, as shown in FIGS. 2 and 5.

Furthermore, in the first embodiment, the paddle shift device 52 is operated by pulling the levers, and in the second embodiment, the paddle shift device 52 is operated by pushing the levers. However, the paddle shift device 52 in the first embodiment may be operated by pushing the levers, and the paddle shift device 52 in the second embodiment may be operated by pulling the levers.

What is claimed is:

1. A vehicle control mode switching device that switches a control mode between a non-control mode in which a control amount is not changed automatically, an auto mode in which the control amount is changed automatically, and a manual mode in which the control amount is changed manually, wherein
the vehicle control mode switching device comprises: first and second operating devices operated by a driver; and an electronic control unit configured to switch the control mode based on operation of the first and second operating devices,
the electronic control unit is configured to switch the control mode between two modes of the three modes to set one of the two modes as a base mode based on the operation of the first operating device, and to switch the control mode between the base mode and a remaining mode other than the two modes among the three modes based on the operation of the second operating device.

2. The vehicle control mode switching device according to claim 1, wherein the second operating device is provided in a position that is easier for the driver to access while driving a vehicle than the first operating device.

3. The vehicle control mode switching device according to claim 1, wherein the operation of the second operating device for switching the control mode between the base mode and the remaining mode is the same regardless of which of the two modes the base mode is.

4. The vehicle control mode switching device according to claim 1, wherein the electronic control unit is configured such that, when switching the control mode from the remaining mode to the base mode based on the operation of the second operating device, the control mode is switched to a mode that was set as the base mode before switching the control mode from the base mode to the remaining mode.

5. The vehicle control mode switching device according to claim 1, wherein the two modes are the non-control mode and the auto mode, and the remaining mode is the manual mode.

6. The vehicle control mode switching device according to claim 5, wherein the electronic control unit is configured such that, when switching the control mode from the auto mode to the manual mode based on the operation of the second operating device in a situation where the control mode is the auto mode, increase or decrease in the control amount when switching the control mode from the auto mode to the manual mode is determined based on an operation manner of the second operating device.

7. The vehicle control mode switching device according to claim 1, wherein the two modes are the non-control mode and the manual mode, and the remaining mode is the auto mode.

8. The vehicle control mode switching device according to claim 7, wherein the electronic control unit is configured such that, when switching the control mode from the auto mode to the manual mode based on the operation of the second operating device in a situation where the control mode is the auto mode, increase or decrease in the control amount when switching the control mode from the auto mode to the manual mode is determined based on an operation manner of the second operating device.

9. The vehicle control mode switching device according to claim 1, wherein the first operating device is a switch provided at a position other than a steering wheel, and the second operating device is one of a paddle shift device and a steering switch provided on the steering wheel.

10. The vehicle control mode switching device according to claim 9, wherein the switch provided at the position other than the steering wheel is a soft switch that is displayed on a display device visible to the driver and can be operated by touch.

11. The vehicle control mode switching device according to claim 1, the electronic control unit is configured, when the control mode is the remaining mode, to display the control mode that was set as the base mode before the control mode was switched from the base mode to the remaining mode on the display device that is visible to the driver.
